(19) United States
(12) Patent Application Publication
(10) Pub. No.: US 2010/0318455 A1
(43) Pub. Date: Dec. 16, 2010

(54) TRADING NITROGEN CREDITS DETERMINED BASED ON THE USE OF A GENETICALLY MODIFIED PLANT

(75) Inventor: Eric Rey, Berkeley, CA (US)

Correspondence Address: MORRISON & FOERSTER LLP, 425 MARKET STREET, SAN FRANCISCO, CA, 94105-2482, US

(73) Assignee: Arcadia Biosciences, Inc., Davis, CA (US)

(21) Appl. No.: 12/518,096

(22) PCT Filed: Dec. 6, 2007
(86) PCT No.: PCT/US07/86675

§ 371 Date: Jun. 5, 2009

Related U.S. Application Data
(60) Provisional application No. 60/873,528, filed on Dec. 6, 2006.

(51) Int. Cl. G06Q 40/00

(52) U.S. Cl. 705/37

(57) ABSTRACT

To trade nitrogen credits on an electronic trading market, an amount of nitrogen applied or to be applied to obtain a desired crop yield using a genetically modified version of a plant is determined. The genetically modified version of the plant has a nitrogen utilization efficiency greater than a non-genetically modified version of the plant. A nitrogen credit is calculated based on the determined amount of nitrogen. The credit is conveyed to one or more potential buyers through the electronic trading market.

### CROSS REFERENCE TO RELATED APPLICATIONS

The present application claims priority to earlier filed U.S. Provisional Application Ser. No. 60/873,528, filed on Dec. 6, 2006, which is incorporated herein by reference in its entirety for all purposes.

### BACKGROUND

1. Field

The present application generally relates to trading nitrogen credits, and, more particularly, to trading nitrogen credits determined based on the use of a genetically modified plant.

2. Description of the Related Art

Agriculture, particularly intensive crop production, is known to make a significant contribution to environmental pollution. Nitrogen is a primary nutrient for crops and its usage has grown rapidly over the last 50 years. Currently more than about 98 million tonnes are applied annually worldwide. However, a large proportion of applied nitrogen is not taken up by crops, often less than 50%. Although nitrogen not taken up by crops can become bound within organic matrices within the soil, significant amounts can be lost from the soil either in gaseous form or leached in water. The latter is of particular concern due to potential contamination of ground water, which can cause eutrophication and pollution of drinking water.

As governments and international entities work to maximize the reduction of environmental pollution, a process to allow for emissions-shifting and effective market optimization that works in conjunction with various regulations and laws will be needed.

### SUMMARY

In one exemplary embodiment, to trade nitrogen credits on an electronic trading market, an amount of nitrogen applied or to be applied to obtain a desired crop yield using a genetically modified version of a plant is determined. The genetically modified version of the plant has a nitrogen utilization efficiency greater than a non-genetically modified version of the plant. A nitrogen credit is calculated based on the determined amount of nitrogen. The credit is conveyed to one or more potential buyers through the electronic trading market.

### DESCRIPTION OF THE FIGURES

The present application can be best understood by reference to the following description taken in conjunction with the accompanying drawing figures, in which like parts may be referred to by like numerals:

FIG. 1 depicts an exemplary embodiment of a plant growing system in which a genetically modified plant is grown creating a nitrogen utilization efficiency;

FIG. 2 depicts an exemplary embodiment of a process to determine nitrogen credits based on the use of a genetically modified plant;

FIG. 3 depicts an exemplary embodiment of a process to receive an amount of nitrogen credit and send one or more bids for the amount of nitrogen credit;

FIG. 4 depicts one exemplary embodiment of an electronic trading market system; and

FIG. 5 depicts an exemplary embodiment of a process to facilitate transactions between a seller and one or more buyers in the electronic trading market system.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

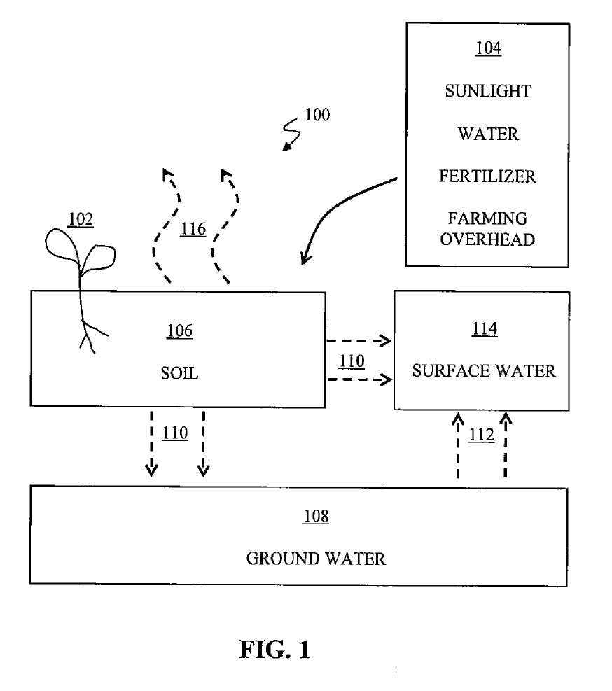

With reference to FIG. 1, system 100 is an exemplary embodiment of a plant growing system. System 100 is depicted with plant 102, which could represent any genetically modified plant or crop. One example of plant 102 could be a monocot or a dicot plant. A monocot plant could be a rice plant, a corn plant, a wheat plant, a rye plant, and the like. A dicot plant could be a tomato plant, a soybean plant, a fruit tree, and the like. One example of a plant 102 could be a variety of canola (Brassica napus), corn (Zea mays), rice (Oryza sativa), and the like, that has been genetically modified to enhance nitrogen utilization, effectively reducing the amount of nitrogen required to maximize crop yield. These exemplary nitrogen efficient plants, such as canola, corn, rice, and the like, can be developed by using a gene that enables greater utilization of nitrogen within the plant. For example, a gene encoding alanine amino transferase can be over-expressed in plants to enable greater utilization of nitrogen within the plant. Other genes involved in nitrogen metabolism and/or utilization can be utilized as well.

As depicted in FIG. 1, several energy inputs 104 are utilized for crop development. These inputs include, but are not limited to, sunlight, water, nitrogen fertilizer, and farming overhead. The farming overhead can include, but is not limited to, tractor operation and irrigation equipment. Only a fraction of the nitrogen that is introduced into soil 106 may be utilized by plant 102. Some of the nitrogen input 104 escapes in water 110 or is volatilized and enters the atmosphere as a gas 116. The nitrogen that escapes in water 110 can lead to contamination of ground water 108 and/or surface water 114. In some cases, the contamination of ground water 108 can lead to eutrophication and pollution 112 of surface water 114.

As little as about 30% of the nitrogen introduced as fertilizer is utilized by typical crops with about 60% escaping soil 106 into the ground water 108 and about 10% of the nitrogen escaping soil 106 into the atmosphere. However, due to recent developments with genetically modified plants, opportunities are arising that will allow the agriculture industries to reduce nitrogen usage for a given crop yield. One example of new technology is genetically modified plants that require significantly less nitrogen fertilizer to generate the same crop yield.

Thus, crop yield can be maintained with substantially lower nitrogen fertilizer application. The lower need for nitrogen means that there is less nitrogen introduced into the farming system 100 which in turn leads to less nitrogen introduced into the ground water 110, surface water 114, and/or atmosphere 108. This reduction in the amount of nitrogen input 104 applied can be used as a basis for calculating an amount of nitrogen credit.

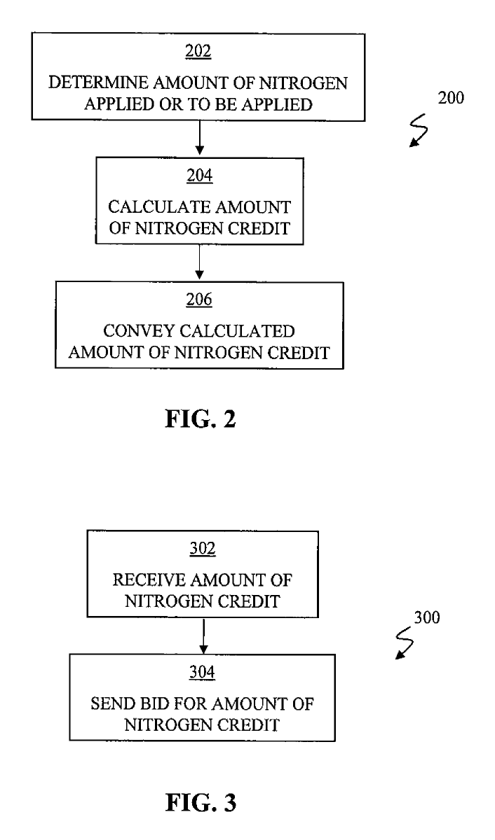

With reference to FIG. 2, process 200 is an exemplary embodiment of a process to trade nitrogen credits on an electronic trading market. In process 200, the nitrogen credits are determined based on the use of genetically modified plants.

In step 202, an amount of nitrogen applied or to be applied to obtain a desired crop yield using a genetically modified version of a plant is determined. As discussed above, the genetically modified version of the plant has a nitrogen utilization efficiency greater than a non-genetically modified version of the plant. For the genetically modified variety of plant, such as canola, corn, rice, and the like, discussed with reference to FIG. 1, about 30-50% less nitrogen is needed to generate the same crop yield as a crop without the alanine amino transferase gene that enables greater efficiency of nitrogen.

For example, assume a desired crop yield of 1,700 to 1,800 lbs. of canola crop per acre. For this desired crop yield, about 80-120 lbs./acre of nitrogen is typically applied. As noted above, about 30-50% less nitrogen is needed to generate the same crop yield when a genetically modified version of the plant is used. Thus, about 40-60 lbs./acre of nitrogen is applied to produce the desired crop yield of 1,700 to 1,800 lbs. of crop per acre using the genetically modified version of the plant.

In one embodiment, farmers can have samples of soil analyzed by agricultural laboratories that will determine specific formulation of soil supplements, including nitrogen, needed to optimize the growth of a crop. The fertilizer formulation will generally include ratios of nitrogen, phosphorus, and potassium.

For example, exemplary formulations of some exemplary dry fertilizers are provided in Table 1 below, with the formulation provided as ratios of nitrogen, phosphorus, potassium, and sulphur:

TABLE 1
Dry Formulations

| Fertilizer | Formulation |
|---|---|
| Urea | 46-0-0 |
| Urea Ammonium Phosphate | 28-26-0 |
| Urea Ammonium Phosphate Potash Sulfate | 13-16-10-12S |

Exemplary formulations of some exemplary liquid fertilizers are provided in Table 2 below, with the formulation provided as ratios of nitrogen, phosphorus, and potassium:

TABLE 2
Liquid Formulations

| Fertilizer | Formulation |
|---|---|
| Anhydrous Ammonia | 82-0-0 |
| Ammonium Nitrate Solution | 20-0-0 |
| Ammonium Phosphate Potassium Liquid | 3-10-10 |
| Urea Ammonium Phosphate Potassium Liquid | 5-5-10 |
| Urea Ammonium Nitrate Liquid, UAN 28 | 28-0-0 |
| Urea Ammonium Nitrate Liquid, UAN 32 | 32-0-0 |

In step 204, an amount of nitrogen credit is calculated based on the amount of nitrogen applied or to be applied. It should be recognized that there are numerous ways the nitrogen credit could be calculated. For example, the amount of nitrogen credit can be the amount of nitrogen that is less than the amount allocated to an entity by the government regulation.

Returning to the example above, assume about 40 lbs./acre of nitrogen is applied or to be applied. Assume that about 120 lbs./acre of nitrogen is the amount allocated. Thus, in this example, the amount of nitrogen credit would be 80 lbs./acre of nitrogen. It should be recognized that the amount of nitrogen credit could be expressed in absolute amount of nitrogen rather than per acre. Thus, in this example, if 100 acres are to be planted, then the amount of nitrogen credit would be 8,000 lbs. of nitrogen.

In step 206, the nitrogen credit is conveyed to potential buyers via an electronic trading market. Potential buyers include, but are not limited to, any commercial, private, or government entity that has an interest in purchasing a nitrogen credit.

After the nitrogen credit is conveyed, one or more bids can be received from one or more potential buyers via an electronic trading market. When a bid is accepted, the nitrogen credit is traded.

With reference to FIG. 3, process 300 is an exemplary embodiment of a process to receive and send a bid for nitrogen credits on the electronic trading market. In step 302, the amount of nitrogen credit sent by the seller is received. As will be described below, it should be recognized that the amount of nitrogen credit does not need to be transmitted directly from the seller to the buyer. In step 304, a bid for the amount of nitrogen credit is sent through the electronic trading market.

One advantage of trading nitrogen credits is that, in addition to managing nitrogen use, they allow for market optimization of efficient reduction of nitrogen use. An entity that can more cheaply reduce its nitrogen use can sell a nitrogen credit and an entity that would require more expensive adjustments to reduce its nitrogen use can purchase a nitrogen credit.

It should be recognized that the nitrogen credit can be purchased for various forms of payment, including money, goods, services, and the like. For example, a provider of crop planting seed or technology can provide seed and/or a license to technology as payment for the nitrogen credit.

Additionally, seed and/or license to technology for the genetically modified version of the plant can be provided at a reduced fee or even free in exchange for rights to at least a portion of the nitrogen credit. It should be recognized that the portion of the nitrogen credit exchanged for the seed and/or license to technology can include any amount greater than zero, including 100%.

For example, assume that an entity provides, either directly or through one or more agents, seed and/or license to technology for the genetically modified version of the plant to a farmer for free in exchange for rights to 50% of the nitrogen credit. Thus, in step 202, the amount of nitrogen applied or to be applied to obtain a desired crop yield using the provided seed and/or the license to technology for the genetically modified version of the plant is determined. In step 204, an amount of nitrogen credit is calculated based on the amount of nitrogen applied or to be applied. The entity that provided the seed and/or license to technology to the farmer has rights to 50 percent of this calculated amount of nitrogen credit.

After the determined amount of nitrogen credit is awarded to the farmer, the farmer can transfer 50 percent of the determined amount of nitrogen credit to the entity that provided the seed and/or license to technology to the farmer. The entity that provided the seed and/or license to technology to the farmer can then trade the nitrogen credit by conveying them to potential buyers via an electronic trading market in step 206. Alternatively, the farmer can trade all of the determined amount of nitrogen credit by conveying them to potential buyers via an electronic trading market in step 206, then transfer 50% of the proceeds to the entity that provided the seed and/or license to technology to the farmer.

Also, it should be recognized that the agreement to trade seed and/or license to technology need not be directly between the entity providing the seed and/or license to technology and the farmer receiving the seed and/or license to technology. Instead, the agreement may be between the entity providing the seed and/or license to technology and a cooperative, governmental agency, regional or provisional government, and the like.

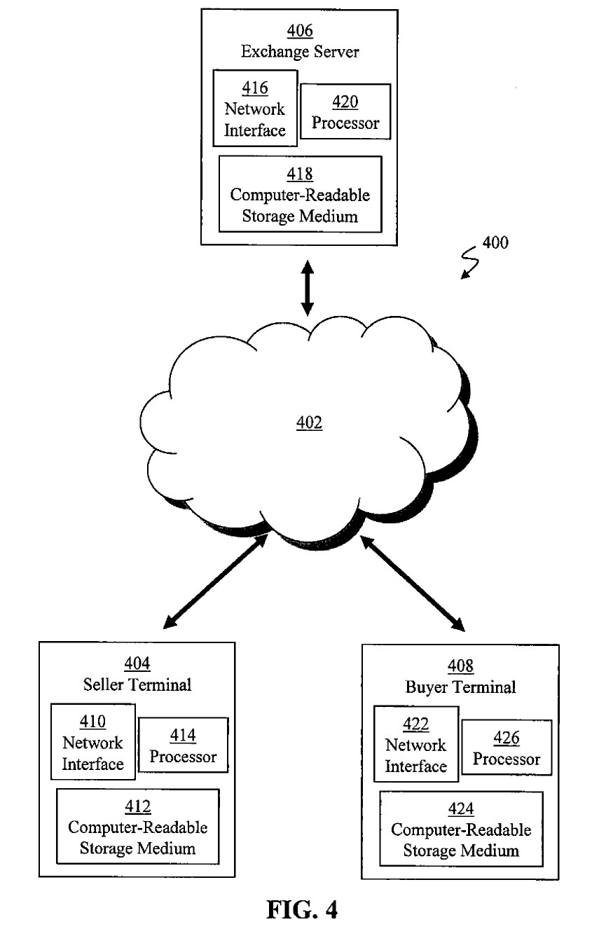

With reference to FIG. 4, system 400 is one exemplary embodiment of an electronic trading market system. The calculated nitrogen credit generated in step 204 (FIG. 2) is conveyed to one or more potential buyers by inputting data regarding the credit into a seller terminal 404. Seller terminal 404 can be a computer or any electronic device, including, but not limited to personal digital assistants (PDAs), telephones, cellular phones, or any other electronic device that has communication functionality.

As depicted in FIG. 4, seller terminal 404 can include a network interface 410, a computer-readable storage medium 412, and a processor 414. Network interface 410 can be configured to be connected to communication medium 402. Computer-readable storage medium 412 can include computer-readable instructions to obtain an amount of nitrogen credit and convey the amount of nitrogen credit through communication medium 402 using network interface 410. Processor 414 can be configured to execute the computer-readable instructions stored in computer-readable storage medium 412. It should be recognized, however, that seller terminal 404 can include various additional components in various configurations.

The data regarding the credit is transported by communication medium 402. Although communication medium 402 is depicted as the Internet, communication medium 402 can be any type of network, including but not limited to, intranets, extranets, or wireless networks.

In one exemplary embodiment, the data from seller terminal 404 is received by exchange server 406. Exchange server 406 can host an exchange application and other software that enables the communication and trading between seller terminal 404 and buyer terminal 408. For example, exchange server 406 can include an Internet-based server and application.

As depicted in FIG. 4, exchange server 406 can include a network interface 416, a computer-readable storage medium 418, and a processor 420. Network interface 416 can be configured to be connected to communication medium 402. Computer-readable storage medium 418 can include computer-readable instructions to facilitate the transaction between seller terminal 404 and one or more buyer terminals 408. Processor 420 can be configured to execute the computer-readable instructions stored in computer-readable storage medium 418. It should be recognized, however, that exchange server 406 can include various additional components in various configurations.

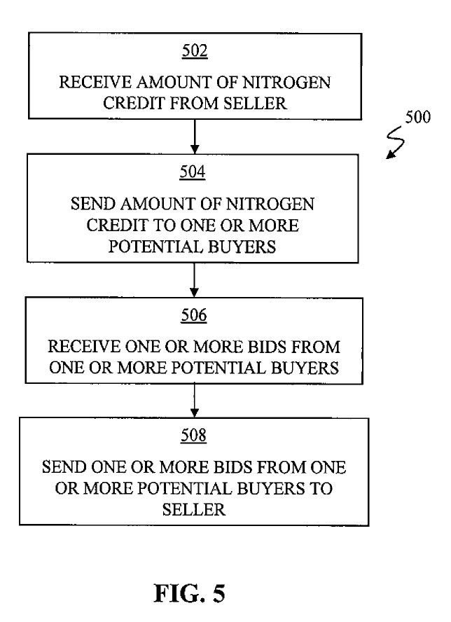

With reference to FIG. 5, process 500 is an exemplary embodiment of a process to facilitate the transaction between seller terminal 404 (FIG. 4) and one or more buyer terminals 408 (FIG. 4). In step 502, an amount of nitrogen credit is received from the seller. In step 504, the amount of nitrogen credit is sent to one or more potential buyers. In step 506, one or more bids are received from one or more potential buyers. In step 508, the one or more bids received from the one or more potential buyers are sent to the seller.

With reference again to FIG. 4, one or more bids can be entered by one or more potential buyers utilizing one or more buyer terminals 408. In FIG. 4, buyer terminal 408 is shown as a single computer but could be any number of electronic devices utilized independently by independent potential buyers.

As depicted in FIG. 4, buyer terminal 408 can include a network interface 422, a computer-readable storage medium 424, and a processor 426. Network interface 422 can be configured to be connected to communication medium 402. Computer-readable storage medium 424 can include computer-readable instructions to receive the amount of nitrogen credit and send one or more bids for the amount of nitrogen credit through communication medium 402 using network interface 422. Processor 426 can be configured to execute the computer-readable instructions stored in computer-readable storage medium 424. It should be recognized, however, that buyer terminal 408 can include various additional components in various configurations.

The bid or bids entered into buyer terminal 408 are conveyed by communication medium 402 and received by seller terminal 404. As described above, the bid or bids can be first received and processed by exchange server 406 before being conveyed to seller terminal 404. Once the bid or bids have been received at seller terminal 404, a bid can be accepted using seller terminal 404.

In the embodiment described above, the transaction between seller terminal 404 and one or more buyer terminals 408 was described as being facilitated by exchange server 406. It should be recognized, however, that the transaction between seller terminal 404 and one or more buyer terminals 408 can be transacted without exchange server 406. For example, the transaction between seller terminal 404 and one or more seller terminals 408 can be transacted on a peer-to-peer basis.

In one exemplary embodiment, the amount of nitrogen credit can be calculated on the seller terminal 404 and/or the exchange server 406. Thus, in this exemplary embodiment, seller terminal 404 can include a network interface configured to be connected to a communication medium. Seller terminal 404 can include an input for inputting an amount of nitrogen applied or to be applied to obtain a desired crop yield using a genetically modified version of a plant, where the genetically modified version of the plant has a nitrogen utilization efficiency greater than a non-genetically modified version of the plant. Seller terminal 404 can include a calculator to calculate the amount of nitrogen credit available to be traded based on the input amount of nitrogen applied or to be applied as described in the example provided above. Seller terminal 404 can include a communicator to communicate the calculated amount of nitrogen credit to one or more potential buyers through the communication medium using the network interface.

Alternatively or additionally, in this exemplary embodiment, exchange server 406 can include a network interface configured to be connected to a communication medium. Exchange server 406 can include a first receiver for receiving an amount of nitrogen applied or to be applied to obtain a desired yield using a genetically modified version of a plant, where the genetically modified version of the plant has a nitrogen utilization efficiency greater than a non-genetically modified version of the plant. Exchange server 406 can include a calculator for calculating the amount of nitrogen credit based on the received amount of nitrogen applied or to be applied as described in the example provided above. Exchange server 406 can include a first sender for sending the amount of nitrogen credit to one or more potential buyer terminals through the communication medium using the network interface. Exchange server 406 can include a second receiver for receiving one or more bids for the amount of nitrogen credit from one or more potential buyer terminals through the communication medium using the network interface. Exchange server 406 can include a second sender for sending the one or more bids for the amount of nitrogen credit to a seller terminal of the amount of nitrogen credit through the communication medium using the network interface.

With regard to this exemplary embodiment, the inventors of the system of the subject application are the first to appreciate that, in an electronic trading system, the technical problem of efficiently and quickly determining an amount of nitrogen credit from the amount of nitrogen applied or to be applied to obtain a desired crop yield using a genetically modified version of a plant and having this information available to all potential buyers simultaneously is solved by performing all of the determination on a seller terminal and/or the exchange server. It is important that the amount of nitrogen credit is efficiently and quickly determined and available to all buyers simultaneously so that it is on the market quickly and so that there is no bias in the market to any particular buyer.

Although exemplary embodiments have been described, various modifications can be made without departing from the spirit and/or scope of the present invention. Therefore, the present invention should not be construed as being limited to the specific forms shown in the drawings and described above.

1. A method of trading nitrogen credits on an electronic trading market, the method comprising:
determining an amount of nitrogen applied or to be applied to obtain a desired crop yield using a genetically modified version of a plant, wherein the genetically modified version of the plant has a nitrogen utilization efficiency greater than a non-genetically modified version of the plant;
calculating an amount of nitrogen credit available to be traded based on the determined amount of nitrogen; and
conveying at least a portion of the calculated amount of nitrogen credit to one or more potential buyers through the electronic trading market.

2. The method of claim 1, further comprising:
receiving one or more bids from one or more potential buyers through the electronic trading market.

3. The method of claim 1, wherein said step of determining an amount of nitrogen applied or to be applied to obtain a desired crop yield using a genetically modified version of a plant comprises determining an amount of nitrogen applied or to be applied to obtain a desired crop yield using a genetically modified canola, corn, or rice.

4. The method of claim 3, wherein said step of determining an amount of nitrogen applied or to be applied to obtain a desired crop yield using a genetically modified canola, corn or rice comprises determining an amount of nitrogen applied or to be applied to obtain a desired crop yield using a genetically modified canola, corn, or rice developed using an alanine amino transferase gene.

5. The method of claim 1, wherein said step of determining an amount of nitrogen applied or to be applied to obtain a desired crop yield using a genetically modified version of a plant comprises determining an amount of nitrogen applied or to be applied to obtain a desired crop yield using a genetically modified plant developed using an alanine amino transferase gene.

6. (canceled)

7. The method of claim 1, wherein calculating an amount of nitrogen credit comprises:
calculating a difference between an amount allocated and the determined amount of nitrogen applied or to be applied.

8. The method of claim 1, further comprising:
receiving seed and/or license to technology from an entity in exchange for rights to at least a portion of the calculated amount of nitrogen credit.

9. The method of claim 8, further comprising:
transferring the at least a portion of the calculated amount of nitrogen credit to the entity, wherein the entity conveys the at least a portion of the amount of nitrogen credit to potential buyers through the electronic trading market.

10. The method of claim 8, further comprising:
transferring at least a portion of proceeds received from trading the calculated amount of nitrogen credit using the electronic trading market to the entity, wherein the at least a portion of proceeds corresponds to the at least a portion of the calculated amount of nitrogen credit.

11. A computer-readable storage medium containing computer-executable instructions to trade nitrogen credits on an electronic trading market, comprising instructions to:
obtain an amount of nitrogen credit available to be traded, wherein the amount of nitrogen credit was calculated by:
determining an amount of nitrogen applied or to be applied to obtain a desired crop yield using a genetically modified version of a plant, wherein the genetically modified version of the plant has a nitrogen utilization efficiency greater than a non-genetically modified version of the plant; and
calculating the amount of nitrogen credit based on the determined amount of nitrogen; and
convey at least a portion of the obtained amount of nitrogen credit to one or more potential buyers through the electronic trading market.

12. The computer-readable storage medium of claim 11, further comprising instructions to:
receive one or more bids from one or more potential buyers through the electronic trading market.

13-19. (canceled)

20. A method of trading nitrogen credits on an electronic trading market, the method comprising:
receiving an amount of nitrogen credit from a seller of the amount of nitrogen credit, wherein the amount of nitrogen credit was calculated by:
determining an amount of nitrogen applied or to be applied to obtain a desired crop yield using a genetically modified version of a plant, wherein the genetically modified version of the plant has a nitrogen utilization efficiency greater than a non-genetically modified version of the plant; and
calculating the amount of nitrogen credit based on the determined amount of nitrogen;
conveying at least a portion of the amount of nitrogen credit to one or more potential buyers;
receiving one or more bids for the amount of nitrogen credit from the one or more potential buyers; and
conveying the one or more bids for the amount of nitrogen credit to the seller of the amount of nitrogen credit.

21. (canceled)

22. The method of claim 20, wherein said step of determining an amount of nitrogen applied or to be applied to obtain a desired crop yield using a genetically modified version of a plant comprises determining an amount of nitrogen applied or to be applied to obtain a desired crop yield using a genetically modified canola, corn, or rice.

23. The method of claim 22, wherein said step of determining an amount of nitrogen applied or to be applied to obtain a desired crop yield using a genetically modified canola, corn or rice comprises determining an amount of nitrogen applied or to be applied to obtain a desired crop yield using a genetically modified canola, corn, or rice was developed using an alanine amino transferase gene.

24. The method of claim 20, wherein said step of determining an amount of nitrogen applied or to be applied to obtain a desired crop yield using a genetically modified version of a plant comprises determining an amount of nitrogen applied or to be applied to obtain a desired crop yield using a genetically modified plant developed using an alanine amino transferase gene.

25. A computer-readable storage medium containing computer-executable instructions to trade nitrogen credits on an electronic trading market, comprising instructions to:
receive an amount of nitrogen credit from a seller of the amount of nitrogen credit, wherein the amount of nitrogen credit was calculated by:
determining an amount of nitrogen applied or to be applied to obtain a desired crop yield using a genetically modified version of a plant, wherein the genetically modified version of the plant has a nitrogen utilization efficiency greater than a non-genetically modified version of the plant; and
calculating the amount of nitrogen credit based on the determined amount of nitrogen;
convey at least a portion of the amount of nitrogen credit to one or more potential buyers;
receive one or more bids for the amount of nitrogen credit from the one or more potential buyers; and
convey the one or more bids for the amount of nitrogen credit to the seller of the amount of nitrogen credit.

26-36. (canceled)

37. The computer-readable storage medium of claim 12, further comprising instructions to:
convey at least one of said one or more bids to a seller of said amount of nitrogen credit.

38. The computer-readable storage medium of claim 37, further comprising instructions to:
receive an acceptance of one of said bids from the a seller of said amount of nitrogen credit; and
convey said acceptance to the potential buyer from whom the bid was received.

39. The method of claim 20, further comprising:
receiving an acceptance of one of the one or more bids from the seller of the amount of nitrogen credit; and
sending the acceptance to the potential buyer that sent the bid.
